(19) United States
(12) Patent Application Publication
(10) Pub. No.: US 2026/0273525 A1
(43) Pub. Date: Sep. 17, 2026

(54) SUBMICRON-SCALE MICROFLUIDIC EXPERIMENTAL APPARATUS UNDER HIGH-TEMPERATURE AND HIGH-PRESSURE CONDITIONS AND USE METHOD THEREOF

(71) Applicant: Southwest Petroleum University, Chengdu (CN)

(72) Inventors: Zhan Meng, Chengdu (CN); Wang Li, Chengdu (CN); Bin Liang, Chengdu (CN); Xueyou Zhang, Chengdu (CN); Yi Pan, Chengdu (CN); Chong Chen, Chengdu (CN); Yang Sun, Chengdu (CN); Yuqi Zeng, Chengdu (CN)

(21) Appl. No.: 19/565,770

(22) Filed: Mar. 13, 2026

(30) Foreign Application Priority Data
Mar. 14, 2025 (CN) 2025103023412

(51) Int. Cl. B01L 3/00

(52) U.S. Cl. CPC B01L 3/5027; B01L 2300/0627; B01L 2300/0858; B01L 2300/12; B01L 2300/14; B01L 2300/1883; B01L 2400/0644; B01L 2400/082

(57) ABSTRACT

A submicron-scale microfluidic experimental apparatus under high-temperature and high-pressure conditions and a method of using the apparatus are provided. The apparatus includes a heating and insulation jacket wrapped around an observation device chamber main body; a chamber main body upper pressure cover is disposed above the observation device chamber main body; a water circulation chamber is sealingly disposed on the chamber main body upper pressure cover; a microscopic observation port is disposed above the water circulation chamber; a rotating bearing is disposed on an outer wall surface of the microscopic observation port and located inside the water circulation chamber; a microchip is disposed inside a microchip holder; a water circulation temperature detection and flow rate controller is connected to a water-cooling circulation outlet and the rotating bearing; a water-cooling device is connected to the water circulation temperature detection and flow rate controller and a water-cooling circulation inlet.

### CROSS-REFERENCE TO RELATED APPLICATION

This application claims priority to Chinese Patent Application No. 202510302341.2, filed on Mar. 14, 2025, which is herein incorporated by reference in its entirety.

### TECHNICAL FIELD

The disclosure relates to the technical field of microscopic observation, and more particularly to a submicron-scale microfluidic experimental apparatus under high-temperature and high-pressure conditions and a use method thereof.

### BACKGROUND

Studying fluid flow laws in microscopic porous media is an important research method in multiple basic fields, covering fluid mechanics, energy development, environmental governance, materials science, biomedicine, etc. Taking the oil and gas field as an example, understanding flow laws of oil, gas, and water in porous media is crucial to improving oil and gas recovery rates, optimizing development plans, and predicting production capacity. Combination of microfluidic chip technology and optical microscopes creates conditions for intuitive study on occurrence states and migration mechanisms of fluid at a pore scale. For deep high-temperature and high-pressure oil and gas reservoirs, microfluidic chip holders are usually used to load microchips to realize simulation of multiphase seepage experiments under high-temperature and high-pressure conditions. Under current technical conditions, a channel size of microfluidic chips fabricated by conventional wet etching usually ranges from several micrometers to hundreds of micrometers. High-end manufacturing processes (such as photolithography) can realize fabrication of channels at 1-micrometer even sub-micrometer level, which can reflect pores of low-permeability oil and gas reservoirs. With continuous reduction of the channel size of microfluidic chips, when precise observation of fluid migration is to be achieved through microfluidic experiments under the high-temperature and high-pressure conditions, higher requirements are put forward for microscopes and microfluidic model holders.

In related art, a Chinese patent with a publication No. CN118130756A discloses a composite apparatus and experimental method for petrophysical experiments and teaching on tight sandstone. This composite apparatus uses a microscope combined with image processing technology to observe a seepage process and distribution state of multiphase fluids in a micro-model chip, but fails to simulate a real formation environment with high temperature and high pressure. Another Chinese patent with a publication No. CN118010587A discloses a clamping device for high-temperature and high-pressure micro-visualization microscopic displacement model and a using method of the clamping device. This clamping device uses a vacuum layer to ensure stable formation temperature conditions during a micro-visualization displacement experiment, and enables continuous observation of the micro-model from different directions. However, the clamping device is large in size and only compatible with stereomicroscopes.

A microfluidic chip holder resistant to high temperature and high pressure is a prerequisite for conducting high-temperature and high-pressure microfluidic experiments. Currently, the stereomicroscopes are used as an observation means for the high-temperature and high-pressure microfluidic experiments. The stereomicroscopes have advantages of long focal length and large observation field of view, but their magnification is limited, with an effective observation size usually of tens of micrometers and above. Correspondingly, optical microscopes or metallographic microscopes can clearly observe fluid conditions in channels within a 10-micrometer range but have deficiencies of too short a focal length. Taking a 100-fold objective lens as an example, its focal length is about 4 millimeters (mm). Observation windows of high-temperature and high-pressure microfluidic holders in related art are generally more than 2 centimeters (cm) thick, which far exceeds a focal length range of high-magnification objective lenses, making them unable to effectively support research on the flow laws of high-temperature and high-pressure fluids in 10-micrometer-level channels.

### SUMMARY

The disclosure aims to provide a submicron-scale microfluidic experimental apparatus under high-temperature and high-pressure conditions, which fully considers problems of short focal length and poor high-temperature resistance of high-magnification objective lenses of conventional optical microscopes when observing high-precision microscopic models under different pressure conditions, thereby realizing high-precision microfluidic visualization experiments under the high-temperature and high-pressure conditions.

To achieve the aforementioned objectives, the disclosure uses the following technical solutions.

In a first aspect, the submicron-scale microfluidic experimental apparatus under the high-temperature and high-pressure conditions provided by the disclosure includes a heating and insulation jacket, an observation device chamber main body, a chamber main body upper pressure cover, a water circulation chamber, a microscopic observation port, a rotating bearing, a microchip, a microchip holder, a water circulation temperature detection and flow rate controller, a water-cooling device, a heating controller, and a microscope.

The heating and insulation jacket is wrapped around the observation device chamber main body. The chamber main body upper pressure cover is disposed above the observation device chamber main body. The water circulation chamber is sealingly disposed on the chamber main body upper pressure cover. The microscopic observation port is disposed above the water circulation chamber. The rotating bearing is disposed on an outer wall surface of the microscopic observation port and located inside the water circulation chamber. The microchip is disposed inside the microchip holder, and the microchip holder is sealingly disposed on a side surface of the observation device chamber main body. The water circulation temperature detection and flow rate controller is connected to a water-cooling circulation outlet of the water circulation chamber through a pipeline and connected to the rotating bearing through a wire. The water-cooling device is connected to the water circulation temperature detection and flow rate controller and a water-cooling circulation inlet of the water circulation chamber through pipelines. The microscope is disposed above the microscopic observation port.

In an embodiment, the submicron-scale microfluidic experimental apparatus under the high-temperature and high-pressure conditions further includes a sapphire glass observation window and a sapphire glass observation window fixing plate. The sapphire glass observation window is sealingly disposed on a bottom of the water circulation chamber through the sapphire glass observation window fixing plate.

In an embodiment, a distance between the sapphire glass observation window and the microchip is not more than 0.1 mm.

In an embodiment, a water circulation rotating blade is disposed on an outer wall surface of the rotating bearing. When the rotating bearing is in operation, the water circulation rotating blade is configured to, under rotation around a central axis of the microscopic observation port, accelerate a flow rate of water circulation.

In an embodiment, the microchip holder includes a microchip fixing plate, a microchip clamping plate, and a connecting assembly. The microchip is placed on the microchip fixing plate, and the microchip fixing plate is fixedly connected to the microchip clamping plate. The connecting assembly is fixedly connected to the microchip clamping plate and is configured to sealingly assemble the microchip holder on the side surface of the observation device chamber main body. A displacement inlet and a displacement outlet are defined on the connecting assembly. The displacement inlet and the displacement outlet are connected to the microchip placed on the microchip clamping plate through pipelines.

In an embodiment, the submicron-scale microfluidic experimental apparatus under the high-temperature and high-pressure conditions further includes a first intermediate container, a second intermediate container, a third intermediate container, a double-cylinder displacement pump, a vacuum pump, and a fluid metering container. The double-cylinder displacement pump is connected to the first intermediate container, the second intermediate container, and the third intermediate container. The first intermediate container, the second intermediate container, and the third intermediate container are individually connected to the displacement inlet through pipelines. The vacuum pump is connected to the displacement outlet through a pipeline and is configured to extract air from the microchip. The fluid metering container is connected to the displacement outlet through a pipeline.

In an embodiment, a hydraulic oil through hole is defined on the microchip clamping plate. A confining pressure inlet and a confining pressure outlet are defined on the chamber main body upper pressure cover. The submicron-scale microfluidic experimental apparatus further includes a confining pressure pump, and the confining pressure pump is connected to the confining pressure inlet through a pipeline.

In a second aspect, a method of using the submicron-scale microfluidic experimental apparatus under the high-temperature and high-pressure conditions provided by the disclosure includes the following steps:
assembling the submicron-scale microfluidic experimental apparatus under the high-temperature and high-pressure conditions;
where the assembling the submicron-scale microfluidic experimental apparatus under the high-temperature and high-pressure conditions includes the following steps:
   placing the microchip on the microchip fixing plate, and threadedly fixing the microchip fixing plate to the microchip clamping plate to obtain the microchip holder; and sealingly assembling the connecting assembly into an inlet on the side surface of the observation device chamber main body;
   fixing the chamber main body upper pressure cover on the observation device chamber main body with fixing bolts; placing the sapphire glass observation window on the sapphire glass observation window fixing plate, and threadedly fixing the sapphire glass observation window on the bottom of the water circulation chamber; screwing the water circulation chamber into a hole in a middle of the chamber main body upper pressure cover through threads and a first rubber sealing ring; and screwing the microscopic observation port into the water circulation chamber through threads; and
   wrapping the heating and insulation jacket around the observation device chamber main body, and connecting the heating and insulation jacket to the heating controller through a wire; connecting the confining pressure pump to the confining pressure inlet on the chamber main body upper pressure cover through a pipeline; connecting the water circulation temperature detection and flow rate controller to the water-cooling circulation outlet defined on the water circulation chamber and the water-cooling device through pipelines; connecting the water-cooling device to the water-cooling circulation inlet defined on the water circulation chamber through a pipeline; connecting the double-cylinder displacement pump to the first intermediate container filled with the water, the second intermediate container filled with the natural gas, and the third intermediate container filled with CO₂ through pipelines; and connecting the first intermediate container, the second intermediate container, and the third intermediate container individually to the displacement inlet on the microchip holder;
attaching an objective lens waterproof sheet to an outermost surface of a front lens of an objective lens of the microscope; placing the objective lens into the microscopic observation port; starting the water circulation temperature detection and flow rate controller and the water-cooling device, starting the heating controller when water circulation is stable; setting a mode of the heating controller to a constant temperature mode, and heating the observation device chamber main body to a target temperature T; after reaching the target temperature T, controlling a rotating speed of the water circulation rotating blade and monitoring a water temperature at the water-cooling circulation outlet in real time to ensure that the water temperature is maintained within a temperature range tolerable for the objective lens of the microscope;
starting the confining pressure pump, slowly injecting hydraulic oil into the observation device chamber main body until no bubbles appear at the confining pressure outlet, then plugging the confining pressure outlet, starting a constant pressure mode of the confining pressure pump, making the hydraulic oil fill a space between the microchip and the sapphire glass observation window through the hydraulic oil through hole, and keeping a constant confining pressure at upper and lower sides of the microchip at a first pressure P₁;
adjusting a height of the objective lens for focusing until a microstructure inside the microchip is clearly observed;
connecting a vacuum pump to the displacement outlet on the microchip holder, starting the vacuum pump to extract air from the microchip, maintaining a pressure for leak detection after reaching a target vacuum degree, closing the displacement outlet after confirming no leakage, and connecting the fluid metering container to the displacement outlet;
turning on a switch of the first intermediate container filled with water, starting the double-cylinder displacement pump to saturate the microchip with water, observing migration of water phase in the microchip, maintaining an internal pressure of a micro-model at a second pressure P₂, and closing the displacement inlet after completing water saturation; and
turning on a switch of the second intermediate container filled with natural gas, starting the double-cylinder displacement pump to pressurize the natural gas to a third pressure P₃, where P₁ is larger than P₃, and P₃ is larger than P₂; opening the displacement inlet, injecting the natural gas into the microchip, and simultaneously opening the displacement outlet; when a specified water saturation is reached during displacement, closing the displacement outlet, and pressurizing the natural gas to an initial formation pressure P₄, where P₁ is larger than P₄; closing the displacement inlet; after gas-water distribution in the microchip stabilizes, keeping a confining pressure constant, and slowly opening the displacement outlet to perform step-by-step pressure drop depletion development; observing and recording migration behavior and distribution state of natural gas and pore water under different depletion pressures through the microscope in real time, and recording a gas-water seepage process during a depletion process;
turning on a switch of the third intermediate container filled with carbon dioxide (CO₂), starting the double-cylinder displacement pump to pressurize the CO₂ to a set displacement pressure P₆, and setting the confining pressure to P₅, where P₅ is larger than P₆; opening the displacement inlet, and injecting the CO₂ into the microchip after depletion development to supplement gas displacement; and observing characteristics of residual gas mobilization, residual water activation, and secondary migration of pore fluids during a CO₂ displacement process through the microscope in real time; and
after experiment is completed, stopping the double-cylinder displacement pump, stopping the confining pressure pump to depressurize the confining pressure, and stopping the heating controller; stopping the water circulation temperature detection and flow rate controller and the water-cooling device when a temperature of the observation device chamber main body drops to room temperature, and cleaning the submicron-scale microfluidic experimental apparatus.

The disclosure has the following beneficial effects.

A focal length of high-magnification objective lenses of conventional optical microscopes is usually within 1 cm, and these objective lenses cannot withstand high temperatures. However, the submicron-scale microfluidic experimental apparatus proposed in the disclosure allows objective lenses of high-magnification optical microscopes to be used for close-range observation of high-precision microchips under the high-temperature and high-pressure conditions, enabling microfluidic visualization experiments.

### BRIEF DESCRIPTION OF DRAWINGS

FIG. 1 illustrates a schematic sectional structural view of a submicron-scale microfluidic experimental apparatus under high-temperature and high-pressure conditions according to an embodiment of the disclosure.

FIG. 2 illustrates a schematic perspective view of a microchip holder of the submicron-scale microfluidic experimental apparatus under the high-temperature and high-pressure conditions according to the embodiment of the disclosure.

FIG. 3 illustrates a schematic overall layout view of the submicron-scale microfluidic experimental apparatus under the high-temperature and high-pressure conditions according to the embodiment of the disclosure.

FIG. 4 illustrates a physical observation image of a microchip under an objective lens of a 100-fold metallographic microscope according to the embodiment of the disclosure.

### DESCRIPTION OF REFERENCE NUMERALS

1: heating and insulation jacket; 2: observation device chamber main body; 3: chamber main body upper pressure cover; 4: fixing bolt; 5: confining pressure inlet; 6: water-cooling circulation inlet; 7: microscopic observation port; 8: water-cooling circulation outlet; 9: rotating bearing; 10: first rubber sealing ring; 11: confining pressure outlet; 12: water circulation chamber; 13: water circulation rotating blade; 14: objective lens waterproof sheet; 15: sapphire glass observation window; 16: displacement inlet; 17: displacement outlet; 18: second rubber sealing ring; 19: microchip; 20: sapphire glass observation window fixing plate; 21: microchip fixing plate; 22: microchip clamping plate; 23: confining pressure pump; 24: microscope; 25: water circulation temperature detection and flow rate controller; 26: water-cooling device; 27: microscopic observation device; 28: first intermediate container; 29: second intermediate container; 30: third intermediate container; 31: double-cylinder displacement pump; 32: heating controller; 33: vacuum pump; 34: fluid metering container; 35: hydraulic oil through hole; 36: connecting assembly.

### DETAILED DESCRIPTION OF EMBODIMENTS

Implementation methods of the disclosure are illustrated below through specific embodiments. Those skilled in the art can easily understand other advantages and effects of this disclosure from the content disclosed in this specification. The disclosure can also be implemented or applied through other different specific implementation methods, and various modifications or changes can be made to details in this specification based on different viewpoints and applications without departing from the spirit of the disclosure. It should be noted that the following embodiments and features in the embodiments can be combined with each other without conflict.

The specific implementation methods of the disclosure will be further described in detail with reference to attached drawings and the embodiments.

### Embodiment 1

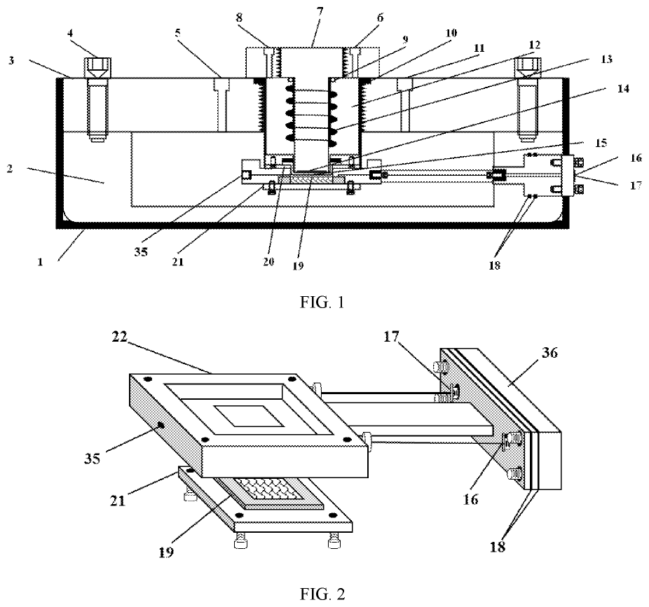

A submicron-scale microfluidic experimental apparatus under high-temperature and high-pressure conditions provided by the disclosure, as illustrated in FIG. 1 through FIG. 3, includes a heating and insulation jacket 1, an observation device chamber main body 2, a chamber main body upper pressure cover 3, a water circulation chamber 12, a microscopic observation port 7, a rotating bearing 9, a microchip 19, a microchip holder, a water circulation temperature detection and flow rate controller 25, a water-cooling device 26, a heating controller 32, and a microscope 24. The heating and insulation jacket 1 is wrapped around the observation device chamber main body 2. The chamber main body upper pressure cover 3 is disposed above the observation device chamber main body 2 through fixing bolts 4. The water circulation chamber 12 is sealingly disposed on the chamber main body upper pressure cover 3. The microscopic observation port 7 is disposed above the water circulation chamber 12. The rotating bearing 9 is disposed on an outer wall surface of the microscopic observation port 7 and located inside the water circulation chamber 12. The microchip 19 is disposed inside the microchip holder, and the microchip holder is sealingly disposed on a side surface of the observation device chamber main body 2. The water circulation temperature detection and flow rate controller 25 is connected to a water-cooling circulation outlet 8 of the water circulation chamber 12 through a pipeline and connected to the rotating bearing 9 through a wire. The water-cooling device 26 is connected to the water circulation temperature detection and flow rate controller 25 and a water-cooling circulation inlet 6 of the water circulation chamber 12 through pipelines. The microscope 24 is disposed above the microscopic observation port 7.

The heating and insulation jacket 1 is a structure with built-in constant-temperature heating and insulation functions. For example, the heating and insulation jacket 1 can be composed of a heating component, a temperature-sensing component, and an insulation layer connected together. The heating component is attached to the observation device chamber main body 2, and the temperature sensing component can be disposed in the insulation layer. The heating component and the temperature-sensing component are both connected to the heating controller 32. The heating controller 32 is configured to control the heating component to work, and, according to a preset target temperature and combined with a temperature signal collected by the temperature sensing component, control the heating component to stop working when the temperature signal reaches the preset target temperature. Apparently, the temperature-sensing component can also be disposed on an outer side of the heating component, in contact with an outer side of the observation device chamber main body 2, so that the temperature signal collected by the temperature-sensing component can better reflect a temperature of the observation device chamber main body 2.

The observation device chamber main body 2 is configured to assemble the microchip holder fixed with the microchip 19. The chamber main body upper pressure cover 3 fixed on an upper end of the observation device chamber main body 2 is configured to facilitate installation of the water circulation chamber 12. For example, the water circulation chamber 12 can be screwed into a hole defined in a middle of the chamber main body upper pressure cover 3 through threads and a first rubber sealing ring 10; meanwhile, the microscopic observation port 7 can be screwed into the water circulation chamber 12 through threads, thereby facilitating installation of the microscope 24. A metallographic microscope is selected as the microscope 24.

Cooling water or heat-conducting oil flows inside the water circulation chamber 12. A temperature of the cooling water or the heat-conducting oil is regulated by the water-cooling device 26 and the water circulation temperature detection and flow rate controller 25 to prevent local overheating and ensure a cooling effect for an objective lens 35 of the microscope 24. The water circulation temperature detection and flow rate controller 25 is configured to detect a temperature and a flow rate of circulation water in the water circulation chamber 12 and adjust a rotating speed of the rotating bearing 9 according to the detected temperature of the circulation water. A specific structure of the water circulation temperature detection and flow rate controller 25 can be, for example, a structure composed of a temperature sensor and a control chip. The temperature sensor can be installed on a pipeline where a temperature is required to be detected, and the control chip can be integrated with the temperature sensor and electrically connected to the temperature sensor, so as to obtain the temperature of the circulation water collected by the temperature sensor. The rotating bearing 9 is an electric rotating shaft, specifically a structure that realizes rotation by a motor driving a rotating shaft. A water circulation rotating blade 13 is disposed on an outer wall surface of the rotating bearing 9. When the rotating bearing 9 is in operation, the water circulation rotating blade 13 rotates around a central axis of the microscopic observation port 7 to accelerate the flow rate of the circulation water. The control chip can adjust the flow rate of the circulation water by controlling the rotating speed of the rotating bearing 9. For example, when the temperature of the circulation water is too high, the rotating speed can be appropriately increased to generate a centrifugal force to accelerate the flow rate of the circulation water. The water-cooling device 26 is a device capable of realizing cooling. For example, the water-cooling device 26 can be a refrigerator, and the circulation water is cooled by the refrigerator before circulation.

In some embodiments, as illustrated in FIG. 1, the submicron-scale microfluidic experimental apparatus under the high-temperature and high-pressure conditions further includes a sapphire glass observation window 15 and a sapphire glass observation window fixing plate 20. The sapphire glass observation window 15 is sealingly disposed on a bottom of the water circulation chamber 12 through the sapphire glass observation window fixing plate 20.

Specifically, the sapphire glass observation window 15 can be placed on the sapphire glass observation window fixing plate 20 and threadedly fixed to the bottom of the water circulation chamber 12. The sapphire glass observation window 15 can be made of sapphire glass.

In some embodiments, as illustrated in FIG. 1, a distance between the sapphire glass observation window 15 and the microchip 19 is not more than 0.1 mm. A thickness of the sapphire glass observation window 15 can be set to 3.9 mm. During observation, the objective lens 35 of the microscope 24 can be placed close to the sapphire glass observation window 15, and a minimum distance between the objective lens 35 and the microchip 19 can be controlled at 4 mm.

In some embodiments, as illustrated in FIG. 2, the microchip holder includes a microchip fixing plate 21, a microchip clamping plate 22, and a connecting assembly 36. The microchip 19 is placed on the microchip fixing plate 21, and the microchip fixing plate 21 is fixedly connected to the microchip clamping plate 22. The connecting assembly 36 is fixedly connected to the microchip clamping plate 22 and is configured to sealingly assemble the microchip holder on the side surface of the observation device chamber main body 2. A displacement inlet 16 and a displacement outlet 17 are defined on the connecting assembly 36, and a second rubber sealing ring 18 is disposed on the connecting assembly 36. The displacement inlet 16 and the displacement outlet 17 are connected to the microchip 19 placed on the microchip clamping plate 22 through pipelines. The connecting assembly 36 is assembled on the microchip clamping plate 22 by bolts matching screw holes defined on the microchip clamping plate 22. The pipelines connected to the displacement inlet 16 and the displacement outlet 17 are connected to a space where the microchip 19 is located through pipe holes defined on the microchip clamping plate 22.

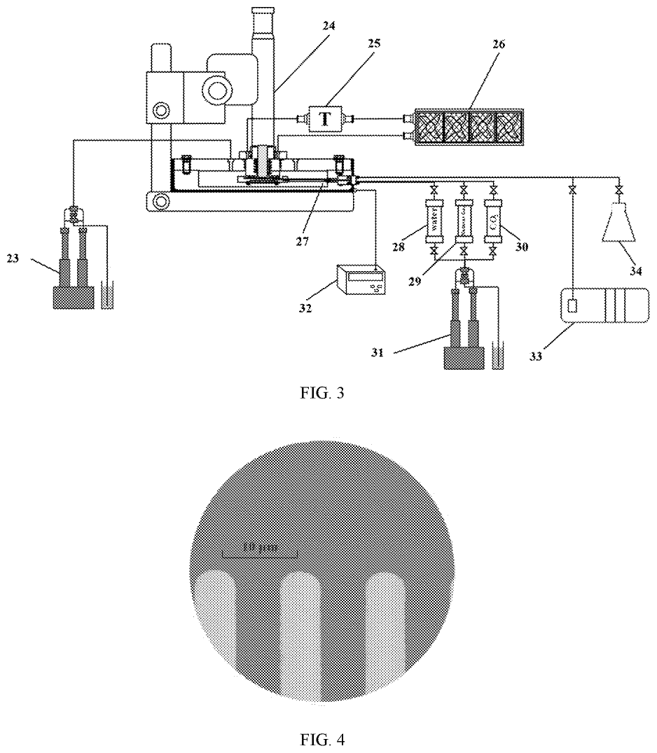

In some embodiments, as illustrated in FIG. 2 and FIG. 3, the submicron-scale microfluidic experimental apparatus under the high-temperature and high-pressure conditions further includes a first intermediate container 28, a second intermediate container 29, a third intermediate container 30, a double-cylinder displacement pump 31, a vacuum pump 33, and a fluid metering container 34. The double-cylinder displacement pump 31 is connected to the first intermediate container 28, the second intermediate container 29, and the third intermediate container 30. The first intermediate container 28, the second intermediate container 29, and the third intermediate container 30 are individually connected to the displacement inlet 16 through pipelines. The vacuum pump 33 is connected to the displacement outlet 17 through a pipeline. The fluid metering container 34 is connected to the displacement outlet 17 through a pipeline.

The first intermediate container 28, the second intermediate container 29, and the third intermediate container 30 are used to load different displacement media. For example, the first intermediate container 28 can hold liquid media, the second intermediate container 29 can hold a gas medium, and the third intermediate container 30 can hold another gas medium. Control valves are respectively disposed on the pipelines connecting the first intermediate container 28, the second intermediate container 29, and the third intermediate container 30 to the displacement inlet 16, and these three corresponding control valves serve as switches for the first intermediate container 28, the second intermediate container 29, and the third intermediate container 30, respectively. The double-cylinder displacement pump 31 is configured to provide displacement power for the first intermediate container 28, the second intermediate container 29, or the third intermediate container 30. The vacuum pump 33 is configured to completely extract air from the microchip. After displacement is completed, the displacement media loaded in the first intermediate container 28, the second intermediate container 29, and the third intermediate container 30 enters the fluid metering container 34 through the displacement outlet 17. The fluid metering container 34 can be equipped with metering components, such as mass sensors, flow sensors, etc., to thereby measure data such as mass and flow rate of the displacement media according to experimental needs.

In some embodiments, as illustrated in FIG. 1 through FIG. 3, a hydraulic oil through hole 35 is defined on the microchip clamping plate 22. A confining pressure inlet 5 and a confining pressure outlet 11 are defined on the chamber main body upper pressure cover 3. The submicron-scale microfluidic experimental apparatus further includes a confining pressure pump 23, and the confining pressure pump 23 is connected to the confining pressure inlet 5 through a pipeline.

The confining pressure pump 23 is configured to pressurize the microchip 19 through the confining pressure inlet 5 and the hydraulic oil through hole 35 when the confining pressure outlet 11 is blocked, so as to achieve a constant confining pressure. When depressurizing the confining pressure, it is only necessary to turn off the confining pressure pump 23 and open the confining pressure outlet 11.

In some embodiments, as illustrated in FIG. 1, an objective lens waterproof sheet 14 is attached to an outermost surface of a front lens of the objective lens of the microscope 24 to play a waterproof role.

### Embodiment 2

The embodiment provides a method of using the submicron-scale microfluidic experimental apparatus under the high-temperature and high-pressure conditions as described in Embodiment 1, including the following step 1 through step 10.

Step 1, experimental equipment and tools are prepared. The microchip 19 is placed on the microchip fixing plate 21. The microchip fixing plate 21 is threadedly fixed to the microchip clamping plate 22 to obtain the microchip holder. The connecting assembly 36 is entirely placed into an inlet on the side surface of the observation device chamber main body 2 and then fixed and sealed with fixing bolts and a second sealing rubber ring 18.

Step 2, the chamber main body upper pressure cover 3 is fixed on the observation device chamber main body 2 with fixing bolts 4. The sapphire glass observation window 15 is placed on the sapphire glass observation window fixing plate 20 made of the sapphire glass and then threadedly fixed on the bottom of the water circulation chamber 12. The water circulation chamber 12 is screwed into the hole in the middle of the chamber main body upper pressure cover 3 by threads and the first rubber sealing ring 10. The microscopic observation port 7 is screwed into the water circulation chamber 12 through threads.

Step 3, the heating and insulation jacket 1 is wrapped around the observation device chamber main body 2 and then connected to the heating controller 32 through a wire. The confining pressure pump 23 is connected to the confining pressure inlet 5 on the chamber main body upper pressure cover 3 through a pipeline. The water circulation temperature detection and flow rate controller 25 is connected to the water-cooling circulation outlet 6 on the water circulation chamber 12 and the water-cooling device 26 through pipelines. The water-cooling device 26 is connected to the water-cooling circulation inlet 8 on the water circulation chamber 12 through a pipeline. The double-cylinder displacement pump 31 is connected to the first intermediate container 28 filled with the water, the second intermediate container 29 filled with the natural gas, and the third intermediate container 30 filled with CO2 through pipelines. The first intermediate container 28, the second intermediate container 29, and the third intermediate container 30 are individually connected to the displacement inlet 16 on the microchip holder.

Step 4, the objective lens waterproof sheet 14 is attached to an outermost surface of a front lens of an objective lens of a metallographic microscope to play the waterproof role. The objective lens is placed into the microscopic observation port 7. The water circulation temperature detection and flow rate controller 25 and the water-cooling device 26 are started. The heating controller 32 is turned on, and a mode of the heating controller 32 is set to a constant temperature mode. The observation device chamber main body 2 is heated to a target temperature T. At the same time, when the observation device chamber main body 2 is heated to a certain temperature, the rotating speed of the water circulation rotating blade 13 is controlled, and a water temperature at the water-cooling circulation outlet 8 is monitored in real time to ensure that the water temperature is maintained within a temperature range tolerable for the objective lens of the metallographic microscope.

Step 5, the confining pressure pump 23 is started. Hydraulic oil is slowly injected into the observation device chamber main body 2 until no bubbles appear at the confining pressure outlet 11. The confining pressure outlet 11 is plugged with a dead plug. A constant pressure mode of the confining pressure pump 23 is started. The hydraulic oil is made to fill a space between the microchip 19 and the sapphire glass observation window 20 through the hydraulic oil through hole 35. A constant confining pressure at upper and lower sides of the microchip 19 is kept at a first pressure P₁.

Step 6, a height of the objective lens is adjusted for focusing until a microstructure inside the microchip 19 is clearly observed.

Step 7, the vacuum pump 33 is connected to the displacement outlet 17 on the microchip holder. The vacuum pump 33 is started to extract the air from the microchip 19. After reaching a target vacuum degree, a pressure is maintained for leak detection. The displacement outlet 17 is closed after confirming no leakage. The fluid metering container 34 is connected to the displacement outlet 17.

Step 8, the switch of the first intermediate container 28 filled with water is turned on. The double-cylinder displacement pump 31 is started to saturate the microchip 19 with water. Migration of water phase in the microchip 19 is observed. An internal pressure of a micro-model is maintained at a second pressure P2. After water saturation is completed, the displacement inlet 16 is closed.

Step 9, a switch of the second intermediate container 29 filled with the natural gas is turned on. The double-cylinder displacement pump 31 is started to pressurize the natural gas to a third pressure P₃, where P₁ is larger than P₃, and P₃ is larger than P₂. The displacement inlet 16 is opened. The natural gas is injected into the microchip 19. At the same time, the displacement outlet 17 is opened. When a specified water saturation is reached during displacement, the displacement outlet 17 is closed. The natural gas is pressurized to an initial formation pressure P₄, where P₁ is larger than P₄. The displacement inlet 16 is closed. After gas-water distribution in the microchip stabilizes, a confining pressure is kept constant. The displacement outlet 17 is slowly opened to perform step-by-step pressure drop depletion development. Migration behavior and distribution state of natural gas and pore water under different depletion pressures are observed and recorded in real time through the metallographic microscope. A gas-water seepage process during a depletion process is recorded.

Step 10, a switch of the third intermediate container 30 filled with the CO₂ is turned on. The double-cylinder displacement pump 31 is started to pressurize the CO₂ to a set displacement pressure P₆. The confining pressure is set to P₅, where P₅ is larger than P₆. The displacement inlet 16 is opened. The CO₂ is injected into the microchip 19 after depletion development to supplement gas displacement. Characteristics of residual gas mobilization, residual water activation, and secondary migration of pore fluids during a CO₂ displacement process are observed in real time through the metallographic microscope.

Step 11, after the experiment is completed, the double-cylinder displacement pump 31 is stopped. The confining pressure pump 23 is stopped to depressurize the confining pressure. The heating controller 32 is stopped. When a temperature of the observation device chamber main body 2 drops to room temperature, the water circulation temperature detection and flow rate controller 25 and the water-cooling device 26 are stopped. The submicron-scale microfluidic experimental apparatus is cleaned.

Resultantly, after going through the aforementioned steps, a physical observation image of the microchip 19 under the objective lens of a 100-fold metallographic microscope is illustrated in FIG. 4. As illustrated in FIG. 4, the submicron-scale microfluidic experimental apparatus proposed in the disclosure allows objective lenses of high-magnification optical microscopes to be used for close-range observation of high-precision microchips under the high-temperature and high-pressure conditions, enabling microfluidic visualization experiments.

The aforementioned embodiments are only used to illustrate the disclosure, but not to limit the disclosure. Those skilled in the art can make various changes and modifications without departing from the spirit and scope of the disclosure, so all equivalent technical solutions also fall within the scope of protection of the disclosure, and the scope of protection of the disclosure is defined by the appended claims.

1. A submicron-scale microfluidic experimental apparatus under high-temperature and high-pressure conditions, comprising a heating and insulation jacket, an observation device chamber main body, a chamber main body upper pressure cover, a water circulation chamber, a microscopic observation port, a rotating bearing, a microchip, a microchip holder, a water circulation temperature detection and flow rate controller, a water-cooling device, a heating controller, and a microscope;
wherein the heating and insulation jacket is wrapped around the observation device chamber main body; the chamber main body upper pressure cover is disposed above the observation device chamber main body; the water circulation chamber is sealingly disposed on the chamber main body upper pressure cover; the microscopic observation port is disposed above the water circulation chamber; the rotating bearing is disposed on an outer wall surface of the microscopic observation port and located inside the water circulation chamber; the microchip is disposed inside the microchip holder, and the microchip holder is sealingly disposed on a side surface of the observation device chamber main body; the water circulation temperature detection and flow rate controller is connected to a water-cooling circulation outlet of the water circulation chamber through a pipeline and connected to the rotating bearing through a wire; the water-cooling device is connected to the water circulation temperature detection and flow rate controller and a water-cooling circulation inlet of the water circulation chamber through pipelines; and the microscope is disposed above the microscopic observation port;
wherein the microchip holder comprises a microchip fixing plate, a microchip clamping plate, and a connecting assembly; the microchip is placed on the microchip fixing plate, and the microchip fixing plate is fixedly connected to the microchip clamping plate; the connecting assembly is fixedly connected to the microchip clamping plate and is configured to sealingly assemble the microchip holder on the side surface of the observation device chamber main body; a displacement inlet and a displacement outlet are defined on the connecting assembly, and the displacement inlet and the displacement outlet are connected to the microchip placed on the microchip clamping plate through pipelines; and
wherein a hydraulic oil through hole is defined on the microchip clamping plate; a confining pressure inlet and a confining pressure outlet are defined on the chamber main body upper pressure cover; the submicron-scale microfluidic experimental apparatus under the high-temperature and high-pressure conditions further comprises a confining pressure pump, and the confining pressure pump is connected to the confining pressure inlet through a pipeline.

2. The submicron-scale microfluidic experimental apparatus under the high-temperature and high-pressure conditions as claimed in claim 1, further comprising a glass observation window and a glass observation window fixing plate, wherein the glass observation window is sealingly disposed on a bottom of the water circulation chamber through the glass observation window fixing plate.

3. The submicron-scale microfluidic experimental apparatus under the high-temperature and high-pressure conditions as claimed in claim 2, wherein a distance between the glass observation window and the microchip is not more than 0.1 millimeters (mm).

4. The submicron-scale microfluidic experimental apparatus under the high-temperature and high-pressure conditions as claimed in claim 1, wherein a water circulation rotating blade is disposed on an outer wall surface of the rotating bearing, and when the rotating bearing is in operation, the water circulation rotating blade is configured to, under rotation around a central axis of the microscopic observation port, accelerate a flow rate of water circulation.

5. The submicron-scale microfluidic experimental apparatus under the high-temperature and high-pressure conditions as claimed in claim 1, further comprising a first intermediate container, a second intermediate container, a double-cylinder displacement pump, and a fluid metering container; wherein the double-cylinder displacement pump is connected to the first intermediate container and the second intermediate container; and the first intermediate container and the second intermediate container, are individually connected to the displacement inlet through pipelines; and the fluid metering container is connected to the displacement outlet through a pipeline.

6. A method of using the submicron-scale microfluidic experimental apparatus under the high-temperature and high-pressure conditions as claimed in claim 5, comprising the following steps:
assembling the submicron-scale microfluidic experimental apparatus under the high-temperature and high-pressure conditions;
embedding an objective lens waterproof sheet on an interior of an objective lens of the microscope; placing the objective lens into the microscopic observation port; turning on the heating controller, setting a mode of the heating controller to a constant temperature mode, and heating the observation device chamber main body to a target temperature T; after reaching the target temperature T, starting the water circulation temperature detection and flow rate controller and the water-cooling device. controlling a rotating speed of a water circulation rotating blade, and monitoring a water temperature at the water-cooling circulation outlet in real time to ensure that the water temperature is maintained within a temperature range tolerable for the objective lens of the microscope;
starting the confining pressure pump, slowly injecting hydraulic oil into the observation device chamber main body until no bubbles appear at the confining pressure outlet, then plugging the confining pressure outlet, starting a constant pressure mode of the confining pressure pump, making the hydraulic oil fill a space between the microchip and a glass observation window through the hydraulic oil through hole, and keeping a constant confining pressure at upper and lower sides of the microchip at a first pressure P₁;
adjusting a height of the objective lens for focusing until a microstructure inside the microchip is clearly observed;
turning on a switch of the first intermediate container filled with water, starting the double-cylinder displacement pump to saturate the microchip with water; observing migration of water phase in the microchip, maintaining an internal pressure of a micro-model at a second pressure P₂; and closing the displacement inlet after completing water saturation; and
turning on a switch of the second intermediate container filled with gas, starting the double-cylinder displacement pump to pressurize the gas to a third pressure P₃, where P₃ is greater than P₂; opening the displacement inlet, injecting the gas into the microchip, and simultaneously opening the displacement outlet; and observing and recording a seepage process of the gas and the water in the microchip through the microscope.

7. The method as claimed in claim 6, wherein the assembling the submicron-scale microfluidic experimental apparatus under the high-temperature and high-pressure conditions comprises the following steps:
placing the microchip on the microchip fixing plate, and threadedly fixing the microchip fixing plate to the microchip clamping plate to obtain the microchip holder; and sealingly assembling the microchip holder into an inlet on the side surface of the observation device chamber main body;
fixing the chamber main body upper pressure cover on the observation device chamber main body with fixing bolts; placing the glass observation window on a glass observation window fixing plate made of sapphire, and threadedly fixing the glass observation window on a bottom of the water circulation chamber; screwing the water circulation chamber into a hole in a middle of the chamber main body upper pressure cover through threads and a rubber sealing ring; and screwing the microscopic observation port into the water circulation chamber through threads;
wrapping the heating and insulation jacket around the observation device chamber main body, and connecting the heating and insulation jacket to the heating controller through a wire; connecting the confining pressure pump to the confining pressure inlet on the chamber main body upper pressure cover through a pipeline; connecting the water circulation temperature detection and flow rate controller to the water-cooling circulation outlet defined on the water circulation chamber and the water-cooling device through pipelines; connecting the water-cooling device to the water-cooling circulation inlet defined on the water circulation chamber through a pipeline; connecting the double-cylinder displacement pump to the first intermediate container filled with the water and the second intermediate container filled with the gas through pipelines; and connecting the first intermediate container and the second intermediate container individually to the displacement inlet on the microchip holder; and
connecting a vacuum pump to the displacement outlet on the microchip holder, starting the vacuum pump, closing the displacement outlet after extracting air from the microchip, and connecting the fluid metering container to the displacement outlet.

8. The method as claimed in claim 7, further comprising steps for ending experiment after observing and recording the seepage process of the gas and the water in the microchip through the microscope; wherein the steps for ending the experiment comprises:
stopping the double-cylinder displacement pump and stop heating; stopping the confining pressure pump when a temperature of the observation device chamber main body drops to room temperature; after depressurizing a confining pressure, stopping the water circulation temperature detection and flow rate controller and the water-cooling device, and cleaning the submicron-scale microfluidic experimental apparatus.
